(19) United States
(12) Patent Application Publication
(10) Pub. No.: US 2020/0336730 A1
(43) Pub. Date: Oct. 22, 2020

(54) WEARABLE DISPLAY DEVICE AND CONTROL METHOD THEREFOR

(71) Applicant: SAMSUNG ELECTRONICS CO., LTD., Suwon-si, Gyeonggi-do (KR)

(72) Inventors: Jae Hee KIM, Suwon-si, Gyeonggi-do (KR); Jae Hyun KIM, Suwon-si, Gyeonggi-do (KR); Yoon Jun BAE, Suwon-si, Gyeonggi-do (KR); Eui-Hyung YOO, Suwon-si, Gyeonggi-do (KR)

(21) Appl. No.: 16/770,986

(22) PCT Filed: Nov. 2, 2018
(86) PCT No.: PCT/KR2018/013227

§ 371 Date: Jun. 9, 2020

(30) Foreign Application Priority Data
Dec. 11, 2017 (KR) 10-2017-0169746

(51) Int. Cl. H04N 13/344; H04N 13/398

(52) U.S. Cl. CPC H04N 13/344; H04N 2013/0077; H04N 13/398

(57) ABSTRACT

A wearable apparatus may include an image display; a content receiver; and a processor configured to process image data received through the content receiver to generate an image frame, and control the image display to display the image frame. The processor may be configured to compare a vertical pixel line of a left edge portion of the image frame with a vertical pixel line of a right edge portion of the image frame, and when it is determined that the image frame is a 360-degree Virtual Reality (VR) image, process the 360-degree VR image.

### TECHNICAL FIELD

The present disclosure relates to a wearable display apparatus and a stereoscopic image display method, and more particularly, to a wearable display apparatus capable of displaying virtual reality (VR) content, and a method of controlling the same.

### BACKGROUND ART

In the related art, display apparatuses refer to output apparatuses displaying visual information converted from received or stored image information to users and have been widely used in various application fields such as individual homes or places of business. For example, the display apparatuses may be monitor devices connected to personal computers or server computers, portable computer devices, navigation devices, televisions (TVs), Internet Protocol televisions (IPTVs), portable terminals, such as smartphones, tablet personal computers (PCs), personal digital assistants (PDAs), or cellular phones, or various display apparatuses used to play advertisements or movies in the industrial field, or various types of audio/video systems.

The display apparatus may also receive content from various content sources such as a broadcasting station, an Internet server, an image reproduction device, a game device, and/or a portable terminal. In addition, the display apparatus may restore (or decode) an image and sound from the content, and output the restored image and sound.

Recently, a study of wearable display apparatuses that can be worn by the user has been conducted. A representative example of the wearable display apparatus is a head mounted display (HMD) in which the display apparatus is fixed to the user's field of view.

Along with the study of the wearable display apparatus, a study of virtual reality content such as a three-dimensional (3D) stereoscopic image and a 360-degree Virtual Reality (VR) image to provide a virtual reality to the user is being conducted together.

However, due to the fact that there is still no standardization of the format of the virtual reality content, the virtual reality content in various formats is provided. In addition, the wearable display apparatus may process the virtual reality content in a specific format, and may allow the user to manually select the format of the virtual reality content.

As such, the user's inconvenience increases due to the user directly inputting the format of the virtual reality content into the wearable display apparatus.

### DISCLOSURE

### Technical Problem

An aspect of the present disclosure is to provide a wearable display apparatus capable of automatically determining a format of virtual reality content, and a method of controlling the same.

Another aspect of the present disclosure is to provide a wearable display apparatus capable of determining a format of a stereoscopic image and a format of 360 degree VR images, and a method of controlling the same.

### Technical Solution

An aspect of the disclosure provides a wearable display apparatus including: an image display; a content receiver; and a processor configured to process image data received through the content receiver to generate an image frame, and control the image display to display the image frame. The processor may be configured to compare a vertical pixel line of a left edge portion of the image frame with a vertical pixel line of a right edge portion of the image frame, and when it is determined that the image frame is a 360-degree Virtual Reality (VR) image, process the 360-degree VR image.

The processor may be configured to compare a left half and a right half of a horizontal pixel line of an upper or lower edge portion of the image frame, and when it is determined that the image frame is a 360-degree top-and-bottom stereoscopic image, process the 360-degree top-and-bottom stereoscopic image.

The processor may be configured to generate the 360-degree top-and-bottom stereoscopic image from the image frame, and control the image display to display a part of the 360-degree top-and-bottom stereoscopic image.

The processor may be configured to compare an upper half and a lower half of the vertical pixel line of the left or right edge portion of the image frame, and when it is determined that the image frame is a 360-degree side-by-side stereoscopic image, process the 360-degree side-by-side stereoscopic image.

The processor may be configured to generate the 360-degree side-by-side stereoscopic image from the image frame, and control the image display to display a part of the 360-degree side-by-side stereoscopic image.

The processor may be configured to compare the vertical pixel line of the left edge portion of the image frame and the vertical pixel line of the right edge portion of the image frame, compare a left half and a right half of a horizontal pixel line of an upper or lower edge portion of the image frame, and when it is determined that the image frame is a top-and-bottom stereoscopic image, process the top-and-bottom stereoscopic image, and control the image display to display the top-and-bottom stereoscopic image.

The processor may be configured to compare the vertical pixel line of the left edge portion of the image frame and the vertical pixel line of the right edge portion of the image frame, compare an upper half and a lower half of the vertical pixel line of the left or right edge portion of the image frame, and when it is determined that the image frame is a side-by-side stereoscopic image, process the side-by-side stereoscopic image, and control the image display to display the side-by-side stereoscopic image.

The processor may be configured to compare the vertical pixel line of the left edge portion of the image frame and the vertical pixel line of the right edge portion of the image frame by comparing a luminance of the vertical pixel line of the left edge portion of the image frame and a luminance of the vertical pixel line of the right edge portion of the image frame.

The processor may be configured to compare the vertical pixel line of the left edge portion of the image frame and the vertical pixel line of the right edge portion of the image frame by comparing a color of the vertical pixel line of the left edge portion of the image frame and a color of the vertical pixel line of the right edge portion of the image frame.

Another aspect of the disclosure provides a method of controlling a wearable display apparatus including: receiving, by a content receiver, image data; generating, by a processor, an image frame by processing the image data; determining, by the processor, the image frame as a 360-degree Virtual Reality (VR) image, by comparing a vertical pixel line of a left edge portion of the image frame and a vertical pixel line of a right edge portion of the image frame; and processing, by the processor, the 360-degree VR image.

The method may further include comparing, by the processor, a left half and a right half of a horizontal pixel line of an upper or lower edge portion of the image frame; and when it is determined that the image frame is a 360-degree top-and-bottom stereoscopic image, processing, by the processor, the 360-degree top-and-bottom stereoscopic image.

The method may further include generating, by the processor, the 360-degree top-and-bottom stereoscopic image from the image frame; and displaying, by an image display, a part of the 360-degree top-and-bottom stereoscopic image.

The method may further include comparing, by the processor, an upper half and a lower half of the vertical pixel line of the left or right edge portion of the image frame; and when it determined that the image frame is a 360-degree side-by-side stereoscopic image, processing, by the processor, the 360-degree side-by-side stereoscopic image.

The method may further include generating, by the processor, the 360-degree side-by-side stereoscopic image from the image frame; and displaying, by an image display, a part of the 360-degree side-by-side stereoscopic image.

The method may further include comparing the vertical pixel line of the left edge portion of the image frame and the vertical pixel line of the right edge portion of the image frame; comparing a left half and a right half of a horizontal pixel line of an upper or lower edge portion of the image frame; and when it is determined that the image frame is a top-and-bottom stereoscopic image, processing the top-and-bottom stereoscopic image; and displaying the top-and-bottom stereoscopic image.

The method may further include comparing the vertical pixel line of the left edge portion of the image frame and the vertical pixel line of the right edge portion of the image frame; comparing an upper half and a lower half of the vertical pixel line of the left or right edge portion of the image frame; and when it is determined that the image frame is a side-by-side stereoscopic image, processing the side-by-side stereoscopic image; and displaying the side-by-side stereoscopic image.

The comparing of the vertical pixel line of the left edge portion of the image frame and the vertical pixel line of the right edge portion of the image frame may include comparing a luminance of the vertical pixel line of the left edge portion of the image frame and a luminance of the vertical pixel line of the right edge portion of the image frame.

The comparing of the vertical pixel line of the left edge portion of the image frame and the vertical pixel line of the right edge portion of the image frame may include comparing a color of the vertical pixel line of the left edge portion of the image frame and a color of the vertical pixel line of the right edge portion of the image frame.

Another aspect of the disclosure provides a wearable display apparatus including: an image display; a content receiver; and a processor configured to process image data received through the content receiver to generate an image frame, and control the image display to display the image frame. The processor may be configured to determine the image frame as one of a 360-degree VR image, a 360-degree top-and-bottom stereoscopic image, a 360-degree side-by-side stereoscopic image, a plane image, a top-and-bottom image, and a side-by-side stereoscopic image based on an edge portion of the image frame. The processor may control the image display to display an image generated from the image frame.

The wearable display apparatus may further include a posture detector configured to detect a posture of the wearable display apparatus. When it is determined that the image frame is one of the 360-degree VR image, the 360-degree top-and-bottom stereoscopic image, and the 360-degree side-by-side stereoscopic image, the processor may be configured to control the image display to display a part of the image according to the output of the posture detector.

### Advantageous Effects

According to an aspect of an embodiment, there is provided a wearable display apparatus capable of automatically determining a format of virtual reality content, and a method of controlling the same.

According to another aspect of an embodiment, there is provided a wearable display apparatus capable of determining a format of a stereoscopic image and a format of a 360-degree VR image, and a method of controlling the same.

### DESCRIPTION OF DRAWINGS

FIG. 1 is a view illustrating a wearable display apparatus and a content source according to an embodiment.

FIG. 2 is an exploded view illustrating a wearable display apparatus according to an embodiment.

FIG. 3 is a view illustrating an example of an image displayed on a wearable display apparatus according to an embodiment.

FIG. 4 is a view illustrating an example of a stereoscopic image displayed on a wearable display apparatus according to an embodiment.

FIG. 5 is a view illustrating another example of an image displayed on a wearable display apparatus according to an embodiment.

FIG. 6 is a view illustrating another example of a stereoscopic image displayed on a wearable display apparatus according to an embodiment.

FIG. 7 is a view illustrating a configuration of a wearable display apparatus according to an embodiment.

FIG. 8 is a view illustrating a configuration of a controller included in a wearable display apparatus according to an embodiment.

FIG. 9 is a view illustrating an example of a plane image.

FIG. 10 is a view illustrating an example of a top-and-bottom stereoscopic image.

FIG. 11 is a view illustrating an example of a side-by-side stereoscopic image.

FIG. 12 is a view illustrating an example of a 360-degree VR image.

FIG. 13 is a view illustrating an example of a 360-degree top-and-bottom stereoscopic image.

FIG. 14 is a view illustrating an example of a 360-degree side-by-side stereoscopic image.

FIGS. 15 and 16 are views illustrating an example of determining whether a pixel line is matched by a wearable display apparatus according to an embodiment.

FIG. 17 is a view illustrating a method of determining a format of an image frame by a wearable display apparatus according to an embodiment.

FIG. 18 is a view illustrating another example of a method of determining a format of an image frame by a wearable display apparatus according to an embodiment.

### MODES OF THE INVENTION

Like reference numerals refer to like elements throughout the specification. Not all elements of embodiments of the disclosure will be described, and description of what are commonly known in the art or what overlap each other in the embodiments will be omitted. The terms as used throughout the specification, such as “˜ part,” “˜ module,” “˜ member,” “˜ block,” etc., may be implemented in software and/or hardware, and a plurality of “˜ parts,” “˜ modules,” “˜ members,” or “˜ blocks” may be implemented in a single element, or a single “˜ part,” “˜ module,” “˜ member,” or “˜ block” may include a plurality of elements.

It will be understood that when an element is referred to as being “connected” to another element, it can be directly or indirectly connected to the other element, wherein the indirect connection includes “connection” via a wireless communication network.

Also, when a part “includes” or “comprises” an element, unless there is a particular description contrary thereto, the part may further include other elements, not excluding the other elements.

Further, when it is stated that a layer is “on” another layer or substrate, the layer may be directly on another layer or substrate or a third layer may be disposed therebetween.

It will be understood that, although the terms first, second, third, etc., may be used herein to describe various elements, it should not be limited by these terms. These terms are only used to distinguish one element from another element.

As used herein, the singular forms “a,” “an” and “the” are intended to include the plural forms as well, unless the context clearly indicates otherwise.

An identification code is used for the convenience of the description but is not intended to illustrate the order of each step. Each of the steps may be implemented in an order different from the illustrated order unless the context clearly indicates otherwise.

Hereinafter, the operation principles and embodiments of the disclosure will be described with reference to the accompanying drawings.

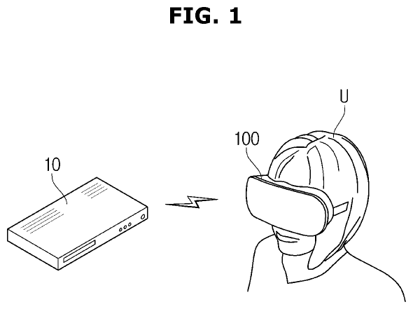

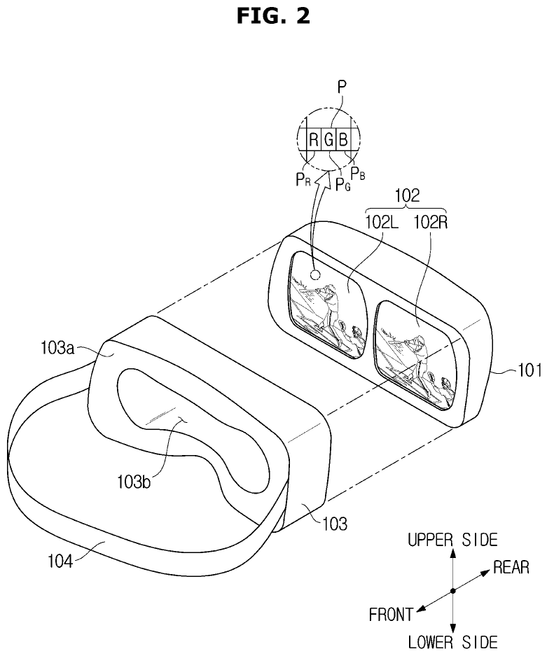

FIG. 1 is a view illustrating a wearable display apparatus and a content source according to an embodiment, and FIG. 2 is an exploded view illustrating a wearable display apparatus according to an embodiment.

Referring to FIGS. 1 and 2, a wearable display apparatus 100 is an apparatus capable of processing image data received from the outside or processing image data stored in a built-in storage medium, and visually displaying the processed image. In particular, the wearable display apparatus 100 may be worn on a body of a user U and fixed to the body of the user U. For example, the wearable display apparatus 100 may be implemented in various product types, such as a head mount display (HMD), smart glasses, or a smart helmet worn on the head or face of the user U.

Hereinafter, the head mount display is described as the wearable display apparatus 100. However, a form of the wearable display apparatus 100 is not limited as long as it is an apparatus that is worn on the body of the user U and visually reproduces an image signal.

As illustrated in FIG. 1, the wearable display apparatus 100 may be connected to a content source 10 by wire or wirelessly, and may receive content including video and audio from the content source 10. Also, the wearable display apparatus 100 may output the video and audio included in the content. For example, the wearable display apparatus 100 may receive television broadcast content from a broadcast receiving apparatus (e.g., a set-top box), receive multimedia content from a content reproduction device, or receive streaming content from a content streaming server through a communication network.

In particular, the wearable display apparatus 100 may receive virtual reality (VR) content from the content source 10 and reproduce the virtual reality content. Due to being worn on the body of the user U, the wearable display apparatus 100 is suitable for reproducing a stereoscopic image and/or a 360-degree VR image.

As illustrated in FIG. 2, the wearable display apparatus 100 may include a main body 101 accommodating a plurality of components for displaying an image, a screen 102 provided on one surface of the main body 101 to display an image I, a seating member 103 for supporting the main body 101 and seated on the body of the user U, and a fixing member 104 for fixing the main body 101 and the seating member 103 to the body of the user U.

The main body 101 may form an appearance of the wearable display apparatus 100, and a component for displaying the image I and a sound A by the wearable display apparatus 100 may be provided in the inside of the main body 101. The main body 101 illustrated in FIG. 2 may be in a shape of a flat plate, but the shape of the main body 101 is not limited to that illustrated in FIG. 2. For example, the main body 101 may have a shape in which left and right ends protrude forward and a center part is curved so as to be concave.

The screen 102 may be formed on the front surface of the main body 101, and the screen 102 may display the image I as visual information. For example, a still image or a moving image may be displayed on the screen 102, and a two-dimensional (2D) plane image or a three-dimensional (3D) stereoscopic image may be displayed.

In particular, the screen 102 may include a right-eye screen 102R and a left-eye screen 102L to display the 3D stereoscopic image. The right-eye screen 102R and the left-eye screen 102L may display images of the same object captured at different positions (a position of a left eye and a position of a right eye), respectively. In other words, the right-eye screen 102R and the left-eye screen 102L may display the image having a difference as compared to a human parallax. Due to the difference between the image displayed on the right-eye screen 102R and the image displayed on the left-eye screen 102L, the user U may feel a three-dimensional effect.

The right-eye screen 102R and the left-eye screen 102L may be implemented as separate display panels, respectively. In addition, the right-eye screen 102R and the left-eye screen 102L may be partitioned from one display panel.

A plurality of pixels P may be formed on the screen 102, and the image displayed on the screen 102 may be formed by a combination of light emitted from the plurality of pixels P. For example, the single image I may be formed on the screen 102 by combining the light emitted by the plurality of pixels P with a mosaic.

Each of the plurality of pixels P may emit the light of various brightness and various colors.

Each of the plurality of pixels P may include a configuration (for example, an organic light emitting diode) capable of emitting the light directly in order to emit the light of various brightness, or a configuration (for example, a liquid crystal panel) capable of transmitting or blocking the light emitted by a backlight unit or the like.

In order to emit the light of various colors, each of the plurality of pixels P may include subpixels P_{R}, P_{G}, and P_{B}. The subpixels P_{R}, P_{G}, and P_{B} may emit light. The red subpixel P_{R} may emit red light, the green subpixel P_{G} may emit green light, and the blue subpixel P_{B} may emit blue light. For example, the red subpixel P_{R} may emit red light having a wavelength of approximately 620 nm (nanometer, 1 billionth of a meter) to 750 nm, the green subpixel P_{G} may emit green light having a wavelength of approximately 495 nm to 570 nm, and the blue subpixel P_{B} may emit blue light having a wavelength of approximately 450 nm to 495 nm.

By the combination of the red light of the red subpixel P_{R}, the green light of the green subpixel P_{G}, and the blue light of the blue subpixel P_{B}, each of the plurality of pixels P may emit the light of various brightness and various colors.

The screen 102 may be provided in the flat plate shape as illustrated in FIG. 2. However, the shape of the screen 102 is not limited to that illustrated in FIG. 2. It may be provided in a shape in which both ends protrude forward and the center portion is curved so as to be concave.

The seating member 103 may be attached to a front of the main body 101, and may fix the main body 101 to the body of the user U.

The seating member 103 may be provided between the body of the user U and the main body 101, and may be seated on the body of the user U.

The seating member 103 may include a curved portion 103a seated on the body of the user U. The curved portion 103a may be in close contact with the body of the user U, for example, the face of the user U. The curved portion 103a may be made of a material having elasticity that can be contracted and expanded by an external force so that a portion in close contact with the body of the user U is maximized. For example, when the user U is in close contact with the face, the shape of the curved portion 103a may change depending on the shape of the face of the user U. When separated from the face of the user U, the curved portion 103a may be restored to its original shape.

The seating member 103 may block external light and limit the field of view of the user U to the screen 102.

A hollow 103b may be formed at a center of the seating member 103 so that the user U can see the screen 102. The user U may see the screen 102 through the hollow 103b of the seating member 103. Thus, in order for the user U to focus on the screen 102, the seating member 103 may block the external light and limit the field of view of the user U to the screen 102.

In addition, because the seating member 103 is seated on the face of the user U, the main body 101 may be located at a fixed position with respect to the face of the user U. In other words, even if the user U moves or turns the head of the user U, the screen 102 formed on the front surface of the main body 101 may be located at a certain position with respect to the face of the user U.

The fixing member 104 may be attached to both ends of the seating member 103, and may fix the main body 101 and the seating member 103 to the body of the user U.

The fixing member 104 may be formed in a strip-shape, and both ends of the fixing member 104 may be attached to both ends of the seating member 103. In addition, the fixing member 104 may be made of the material having the elasticity that can be expanded and contracted by the external force.

The seating member 103 may be in close contact with the face of the user U, and the fixing member 104 may surround the head of the user U. Due to the elasticity of the fixing member 104, the seating member 103 may be fixed to the face of the user U.

The fixing member 104 is not limited to the strip-shape illustrated in FIG. 2. The seating member 103 and the main body 101 are not limited in form as long as the seating member 103 and the main body 101 can be fixed to the body of the user U.

As described above, the wearable display apparatus 100 may be fixed to the face of the user U and may be located at the certain position with respect to the face of the user U. As a result, the screen 102 of the wearable display apparatus 100 may also be located at the certain position with respect to the face of the user U.

As a result, the wearable display apparatus 100 may be suitable for displaying a virtual reality image such as the stereoscopic image and the 360-degree VR image.

In addition, the wearable display apparatus 100 may display the virtual reality image in various ways.

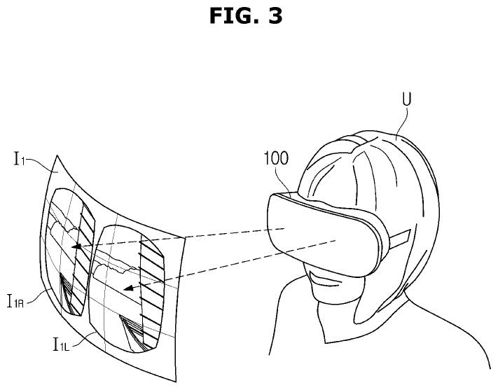

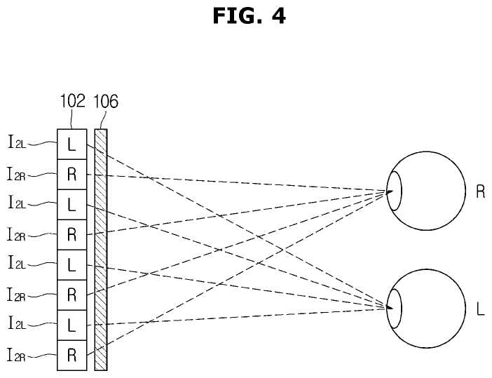

FIG. 3 is a view illustrating an example of an image displayed on a wearable display apparatus according to an embodiment, and FIG. 4 is a view illustrating an example of a stereoscopic image displayed on a wearable display apparatus according to an embodiment. FIG. 3 illustrates a stereoscopic binocular image I1 displayed on the wearable display apparatus 100 and the wearable display apparatus 100 separately, but this is only for understanding. In other words, the stereoscopic binocular image I1 may be displayed on the screen 102 of the wearable display apparatus 100, and is not displayed on the outside of the wearable display apparatus 100 as illustrated in FIG. 3.

As illustrated in FIG. 3, the wearable display apparatus 100 may display, for example, the stereoscopic binocular image I1.

The stereoscopic binocular image I1 may include a left-eye image I1L and a right-eye image I1R. The left-eye image I1L and the right-eye image I1R may be spatially separated and displayed side by side on the screens 102R and 102L.

As illustrated in FIG. 4, the left-eye image I1L displayed on the left-eye screen 102L may be seen in the left eye of the user U, and the right-eye image I1R displayed on the right-eye screen 102R may be seen in the right eye of the user U. In other words, the user U may view the different images I1L and I1R through the left and right eyes.

In addition, the wearable display apparatus 100 may further include a partition wall 105 that partitions the left-eye screen 102L and the right-eye screen 102R. By the partition wall 105, the user U cannot see the left-eye image I1L displayed on the left-eye screen 102L through the right eye, and cannot see the right-eye image I1R displayed on the right-eye screen 102R through the left eye.

The wearable display apparatus 100 may display the left-eye image I1L and the right-eye image I1R on the left-eye screen 102L and the right-eye screen 102R, respectively, in a predetermined manner according to the format of the stereoscopic image.

For example, when the stereoscopic image is a side-by-side stereoscopic image, a left image of the side-by-side stereoscopic image may be displayed on the left-eye screen 102L and a right image of the side-by-side stereoscopic image may be displayed on the right-eye screen 102R. However, the present disclosure is not limited thereto, and the right image of the side-by-side stereoscopic image may be displayed on the left-eye screen 102L and the left image of the side-by-side stereoscopic image may be displayed on the right-eye screen 102R.

In addition, when the stereoscopic image is a top-and-bottom stereoscopic image, a top image of the top-and-bottom stereoscopic image may be displayed on the left-eye screen 102L and a bottom image of the top-and-bottom stereoscopic image may be displayed on the right-eye screen 102R. However, the present disclosure is not limited thereto, and the bottom image of the top-and-bottom stereoscopic image may be displayed on the left-eye screen 102L and the top image of the top-and-bottom stereoscopic image may be displayed on the right-eye screen 102R.

The left-eye image I1L and the right-eye image I1R may be different or identical to each other.

For example, the left-eye image I1L and the right-eye image I1R may be images obtained by capturing the same object at different positions (the position of the left eye and the position of the right eye), respectively. In other words, the left-eye image I1L and the right-eye image I1R may be as different as the human parallax. At this time, the user U may view the left-eye image I1L with the left eye and the right-eye image I1R with the right eye. Due to the difference between the left-eye image I1L and the right-eye image I1R, the user U may feel the three-dimensional effect.

As such, the wearable display apparatus 100 may display the stereoscopic binocular image I1 in which the left-eye image I1L and the right-eye image I1R are spatially separated on the screen 102. Due to the left-eye image I1L and the right-eye image I1R, the user U may experience the three-dimensional effect.

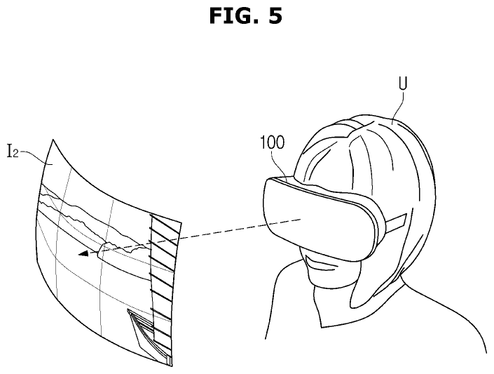

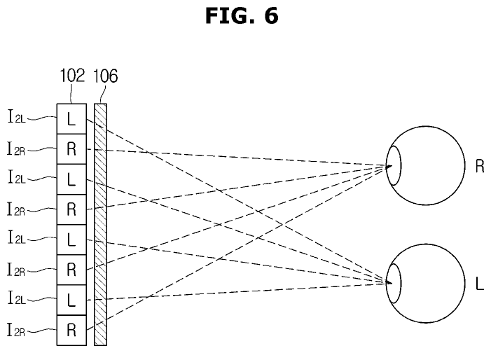

FIG. 5 is a view illustrating another example of an image displayed on a wearable display apparatus according to an embodiment, and FIG. 6 is a view illustrating another example of a stereoscopic image displayed on a wearable display apparatus according to an embodiment. FIG. 4 illustrates a single stereoscopic image I2 displayed on the wearable display apparatus 100 and the wearable display apparatus 100 separately, but this is only for understanding. In other words, the single stereoscopic image I2 may be displayed on the screen 102 of the wearable display apparatus 100, and is not displayed on the outside of the wearable display apparatus 100 as illustrated in FIG. 4.

As illustrated in FIG. 5, the wearable display apparatus 100 may display, for example, the single stereoscopic image I2.

Unlike the stereoscopic binocular image I1 illustrated in FIG. 3, the single stereoscopic image I2 may not include the left-eye image and the right-eye image arranged side by side. In other words, the single stereoscopic image I2 may express the three-dimensional effect by itself.

The single stereoscopic image I2 may include a left-eye image I2L and a right-eye image I2R alternately distributed on different lines. For example, the left-eye image I2L may be displayed in an odd column of the single stereoscopic image I2, and the right-eye image I2R may be displayed in an even column of the single stereoscopic image I2.

Further, according to the embodiment, the single stereoscopic image 12 may include the left-eye image I2L and the right-eye image I2R displayed alternately according to a frame. For example, the left-eye image I2L may be displayed in a first frame, and the right-eye image I2R may be displayed in a second frame.

In addition, the left-eye image I2L of the single stereoscopic image 12 may be seen in the left eye of the user U, and the right-eye image I2R of the single stereoscopic image I2 may be seen in the right eye of the user U.

As illustrated in FIG. 6, in order to display the stereoscopic image using the single stereoscopic image I2, the wearable display apparatus 100 may include an optical member 106 attached to the screen 102 or provided at a position adjacent to the screen 102.

The screen 102 may alternately display the strip-shaped left-eye image I2L fragment and the strip-shaped right-eye image I2R fragment side by side with each other.

The optical member 106 may have various optical structures to separate the left-eye image I2L piece and the right-eye image I2R piece.

For example, the optical member 106 may include a polarizing film. The polarizing film may include a plurality of first left-eye polarizing films and a plurality of first right-eye polarizing films arranged side by side. The first left-eye polarizing films may be disposed at a position corresponding to the left-eye image piece I2L, and the first right-eye polarizing films may be disposed at a position corresponding to the right-eye image piece I2R. In addition, the wearable display apparatus 100 may further include second left-eye polarizing films provided at a position corresponding to the left eye of the user U and second right-eye polarization films provided at a position corresponding to the right eye of the user U. The user U may see the left-eye image piece I2L that has passed through the first left-eye polarization film and the second left-eye polarization film through the left eye, and may see the right-eye image piece I2R that has passed through the first right-eye polarization film and the second right-eye polarization film through the right eye.

As another example, the optical member 106 may include a lenticular lens. The lenticular lens may be provided on the front surface of the screen 102. A plurality of semicircular pillars that are convex toward an opposite side of the screen 102 may be included. The plurality of semicircular pillars may be disposed at positions corresponding to the left-eye image piece I2L and the right-eye image piece I2R. The light forming the left-eye image I2L and the light forming the right-eye image I2R may be refracted in different directions by a semicircular pillar 108a. For example, the light forming the left-eye image I2L may be refracted toward the left eye of the user U by the left convex surface of the semicircular pillar, and the light forming the right-eye image I2R may be refracted toward the right eye of the user U by the right convex surface of the semicircular pillar. As a result, the user U may see the left-eye image I2L that has passed through the left convex surface of the semicircular pillar through the left eye, and may see the right-eye image I2R that has passed through the right convex surface of the semicircular pillar through the right eye.

As another example, the optical member 106 may include a parallax barrier. The parallax barrier may include a plurality of light blocking barriers and a plurality of slots arranged side by side with each other. The light forming the left-eye image I2L and the light forming the right-eye image I2R may pass through the slot. Among the light forming the left-eye image I2L, the light toward the left eye of the user U may pass through the slot, and the light traveling in a different direction may be blocked by the light blocking barrier. In addition, among the light forming the right-eye image I2R, the light toward the right eye of the user U may pass through the slot, and the light traveling in the different direction may be blocked by the light blocking barrier. As a result, the user U may see the left-eye image I2L that has passed through the slot through the left eye, and may see the right-eye image I2R that has passed through the slot through the right eye.

In this way, the wearable display apparatus 100 may provide the three-dimensional effect to the user U by using the parallax between the left-eye image I2L and the right-eye image I2R.

As described above, the wearable display apparatus 100 may display the left-eye image I1L and the right-eye image I1R side by side or alternately display a part of the left-eye image I2L and a part of the right-eye image I2R to display the stereoscopic image.

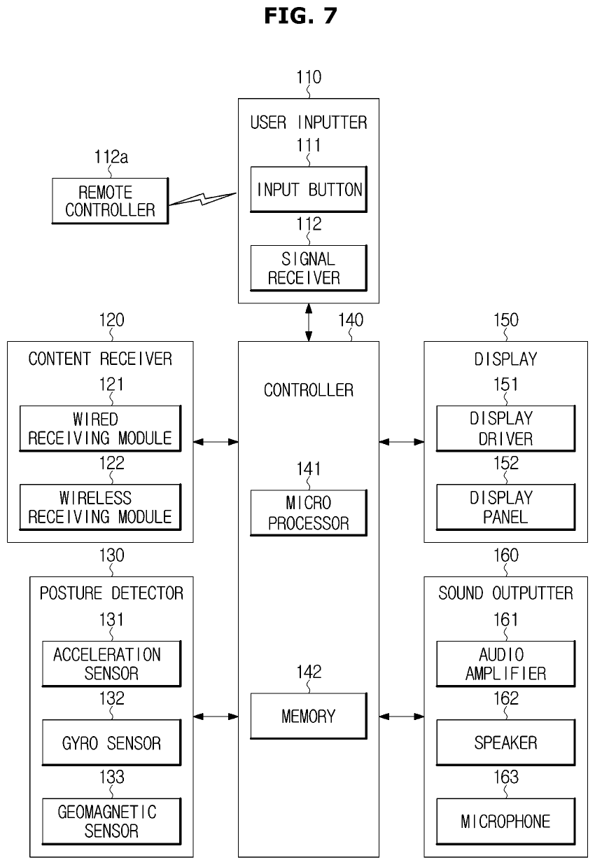

FIG. 7 is a view illustrating a configuration of a wearable display apparatus according to an embodiment.

The wearable display apparatus 100 may include a user inputter 110 for receiving a user input from the user, a content receiver 120 for receiving content from the content source 10, a posture detector 130 for detecting a posture of the wearable display apparatus 100, a controller 140 for processing the content received by the content receiver 120, a display 150 for displaying an image processed by the controller 140, and a sound outputter 160 for outputting sound processed by the controller 140.

The user inputter 110 may include input buttons 111 for receiving the user input. For example, the user inputter 110 may include a power button for turning on or off the wearable display apparatus 100, a source selection button for selecting the content source 10, a sound control button for adjusting the volume of the sound output by the wearable display apparatus 100, and the like.

The input buttons 111 may each receive the user input and output an electrical signal corresponding to the user input to the controller 140. The input buttons 111 may be implemented by various input devices, such as a push switch, a touch switch, a dial, a slide switch, a toggle switch, and the like.

The user inputter 110 may also include a signal receiver 112 for receiving a remote control signal of a remote controller 112a. The remote controller 112a for receiving the user input may be provided separately from the wearable display apparatus 100, and may receive the user input and transmit a radio signal corresponding to the user input to the wearable display apparatus 100. The signal receiver 112 may receive the radio signal corresponding to the user input from the remote controller 112a and output an electrical signal corresponding to the user input to the controller 140.

The content receiver 120 may include a wired receiving module 121 for receiving content over the wire from the content source 10, and a wireless receiving module 122 for wirelessly receiving content from the content source 10.

The wired receiving module 121 may receive content from the content source 10 through various types of image transmission cables.

The wired receiving module 121 may receive the content from the content source 10 through a component (YPbPr/RGB) cable, a composite (composite video blanking and sync (CVBS)) cable, a high definition multimedia interface (HDMI) cable, a universal serial bus (USB) cable, an Ethernet (IEEE 802.3 technology standard) cable, and the like.

When receiving the content from the content source 10 through the wired receiving module 121, the wearable display apparatus 100 may receive image frame data from the content source 10. Here, the image frame data may represent uncompressed image data as a bit stream representing an image of one frame.

The wired receiving module 121 receives the image data through the image transmission cable, so a data rate is not limited. Accordingly, the wired receiving module 121 may receive the image frame data from the content source 10 as it is.

The wireless receiving module 122 may receive the content from the content source 10 using various wireless communication standards.

For example, the wireless receiving module 122 may receive the content wirelessly from the content source 10 using Wi-Fi (WiFi™, IEEE 802.11 technology standard), Bluetooth (Bluetooth™, IEEE 802.15.1 technology standard), ZigBee (ZigBee™, IEEE 802.15.4 technology standard), and the like. Also, the wireless receiving module 122 may receive the content wirelessly from the content source 10 using CDMA, WCDMA, GSM, Long Term Evolution (LTE), WiBro, and the like.

When receiving the content from the content source 10 through the wireless receiving module 122, the wearable display apparatus 100 may receive compressed/encoded image data from the content source 10. Here, the compressed/encoded image data may represent a bit stream in which the image of one frame or the image of a plurality of frames is compressed/encoded. For example, the image frame data may be compressed/encoded by image compression standards such as H.264/MPEG-4 AVC (Moving Picture Experts Group-4 Advance Vide Coding) or H.265/HEVC (High Efficiency Video Coding). By compressing/encoding the image frame data, the compressed/encoded image data may have a smaller capacity (or size) than the original image frame data.

Since the wireless receiving module 122 receives the image data wirelessly, the data transmission rate is limited. Accordingly, the wireless receiving module 122 may receive the compressed/encoded image data from the content source 10.

As such, the content receiver 120 may receive the content wired or wirelessly from the content source 10 and output the received content to the controller 140.

The posture detector 130 may detect a movement and the posture of the wearable display apparatus 100 in a three-dimensional space. In addition, the posture detector 130 may detect a linear movement acceleration, a linear movement speed, a linear movement displacement, a linear movement direction, a tilt, a rotational movement angular velocity, a rotational movement angular displacement, and/or a rotational direction (an axial direction of the rotational movement) of the wearable display apparatus 100 fixed to the body of the user U while the user U is moving.

The posture detector 130 may include an acceleration sensor 131 for detecting the linear movement of the wearable display apparatus 100, a gyro sensor 132 for detecting the rotational movement of the wearable display apparatus 100, and a geomagnetic sensor 133 for detecting earth's magnetic field.

The acceleration sensor 131 may measure x-axis acceleration, y-axis acceleration and/or z-axis acceleration (3-axis linear acceleration) by the linear movement of the wearable display apparatus 100.

For example, the acceleration sensor 131 may measure the linear movement acceleration of the wearable display apparatus 100 based on the acceleration (gravity acceleration) caused by earth's gravity. The acceleration sensor 131 may measure a vector sum of the gravity acceleration and the linear movement acceleration, and determine the linear movement acceleration from the measured value. The acceleration sensor 131 may calculate the linear movement speed of the wearable display apparatus 100 from the linear movement acceleration of the wearable display apparatus 100, and may calculate the linear movement displacement of the wearable display apparatus 100 from a preceding movement speed of the wearable display apparatus 100.

In addition, the acceleration sensor 131 may determine the posture of the wearable display apparatus 100 based on the change in the direction of gravity acceleration.

The gyro sensor 132 may measure the angular velocity around an x-axis, the angular velocity around a y-axis and/or the angular velocity around a z-axis (3-axis angular velocity) by the rotational movement of the wearable display apparatus 100.

For example, the gyro sensor 132 may measure the rotational movement angular velocity of the wearable display apparatus 100 using the Coriolis force by rotation. The gyro sensor 132 may measure the Coriolis force and calculate the rotational movement angular velocity of the wearable display apparatus 100 from the Coriolis force.

The gyro sensor 132 may calculate a rotational movement displacement of the wearable display apparatus 100 from the rotational movement angular velocity of the wearable display apparatus 100.

The geomagnetic sensor 133 may measure an x-axis component, a y-axis component, and a z-axis component of the earth's magnetic field passing through the wearable display apparatus 100.

For example, the geomagnetic sensor 133 may measure earth's magnetic field passing through the wearable display apparatus 100 using the Hall effect. The Hall effect may mean that an electromotive force is generated in a direction perpendicular to the current and the magnetic field when the magnetic field is formed in a direction perpendicular to the current in the semiconductor through which the current flows. The geomagnetic sensor 133 may measure the electromotive force due to the Hall effect and calculate earth's magnetic field from the electromotive force due to the Hall effect.

In particular, the geomagnetic sensor 133 may calculate a direction in which the wearable display apparatus 100 faces, that is, the posture of the wearable display apparatus 100.

As such, the posture detector 130 may output information about the movement such as the linear movement acceleration, the linear movement speed, the linear movement displacement, the linear movement direction, the rotational movement angular velocity, the rotational movement angular displacement and/or the rotational direction (the axial direction of the rotational movement) of the wearable display apparatus 100 and information about the posture such as the tilt of the wearable display apparatus 100 to the controller 140.

The controller 140 may control the content receiver 120, the posture detector 130, the display 150 and/or the sound outputter 160 according to the user input received through the user inputter 110. For example, when the user input for selecting the content source 10 is received, the controller 140 may control the content receiver 120 to receive content data from the selected content source 10. In addition, when the user input for image adjustment and/or sound adjustment is received, the controller 140 may control the display 150 and/or the sound outputter 160 to adjust the image and/or sound.

The controller 140 may process the image data received by the content receiver 120. For example, the controller 140 may restore the image frame data by decoding the compressed/encoded image data, and may process the restored image frame data to render the stereoscopic image. The controller 140 may output all or part of the stereoscopic image to the display 150 according to the output of the posture detector 130.

The controller 140 may include a microprocessor 141 and a memory 142.

The memory 142 may store programs and data for controlling components included in the wearable display apparatus 100 and temporarily store control data generated during controlling of the components included in the wearable display apparatus 100.

The memory 142 may store programs and data for decoding the image data received by the content receiver 120 and programs and data for reproducing the stereoscopic images from the decoded image data. In addition, the memory 142 may store temporary image data generated during decoding of the image data or generated during rendering of the stereoscopic image.

The memory 142 may include a non-volatile memory such as ROM or flash memory for storing the data for a long period of time, a volatile memory such as static random access memory (S-RAM) or dynamic random access memory (D-RAM) for temporarily storing the data.

The microprocessor 141 may generate a control signal for controlling the content receiver 120, the posture detector 130, the display 150 and/or the sound outputter 160 based on the user input from the user inputter 110.

The microprocessor 141 may receive the image data from the content receiver 120, decode the image data according to the programs and data stored in the memory 142, and render the stereoscopic image.

The microcontroller 141 may include an operation circuit to perform logic operations and arithmetic operations and a memory circuit to temporarily store computed data.

The operation of the controller 140 is described in more detail below.

The display 150 may include a display panel 152 for visually displaying the image and a display driver 151 for driving the display panel 152.

The display panel 152 may include a pixel serving as a unit for displaying the image. Each of the pixels may receive an electrical signal representative of the image from the display driver 151 and output an optical signal corresponding to the received electrical signal. As described above, the optical signals output by the plurality of pixels may be combined and displayed on the display panel 152.

For example, the display panel 152 may be provided with the plurality of pixels, and the image displayed on the display panel 152 may be formed by a combination of light emitted from the plurality of pixels. For example, a single image may be formed on the display panel 152 by combining light emitted by the plurality of pixels as a mosaic. As described above, each of the plurality of pixels may emit light of various brightness and various colors, and each of the plurality of pixels in order to emit light of various colors may include the red subpixel, the green subpixel, and the blue subpixel.

The display panel 152 may be implemented by various types of panels such as a liquid crystal display (LCD) panel, a light emitting diode (LED) panel, and an organic light emitting diode (OLED) panel.

According to the embodiment, the display panel 152 may be divided into a plurality of regions. For example, the display panel 152 may be divided into a left region for displaying the left image and a right region for displaying the right image. The left region of the display panel 152 may form the left-eye screen 102L, and the right region of the display panel 152 may form the right-eye screen 102R.

Further, according to the embodiment, the display 150 may include a plurality of display panels. For example, the display 150 may include a left display panel for displaying the left-eye image and a right display panel for displaying the right-eye image. The left display panel may form the left-eye screen 102L, and the right display panel may form the right-eye screen 102R.

The display driver 151 may receive the image data from the controller 140 and drive the display panel 152 to display the image corresponding to the received image data. Particularly, the display driver 151 may transmit an electrical signal corresponding to the image data to each of the plurality of pixels constituting the display panel 152.

When the display driver 151 transmits the electrical signal corresponding to the image data to each pixel constituting the display panel 152, each pixel may output light corresponding to the received electrical signal, and the light output from the each pixel may be combined to form the single image.

The sound outputter 160 may include an audio amplifier 161 for amplifying sound, a speaker 162 for acoustically outputting the amplified sound, and a microphone 163 for collecting ambient sound.

The controller 140 may process the sound data and convert the sound data into a sound signal, and the audio amplifier 161 may amplify the sound signal output from the controller 140.

The speaker 162 may convert the sound signal amplified by the audio amplifier 161 to sound (sound waves). For example, the speaker 162 may include a thin film that vibrates according to the electrical sound signal, and the sound waves may be generated by vibration of the thin film.

The microphone 163 may collect the ambient sound of the wearable display apparatus 100 and convert the collected sound into the electrical sound signal. The sound signal collected by the microphone 163 may be output to the controller 140.

As described above, the wearable display apparatus 100 may receive the image data from the content source 10 and render the stereoscopic image from the image data.

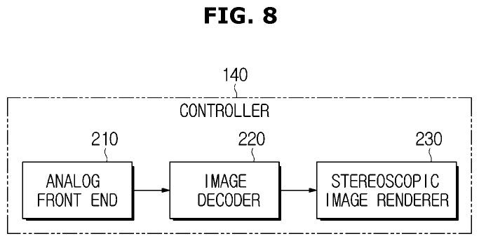

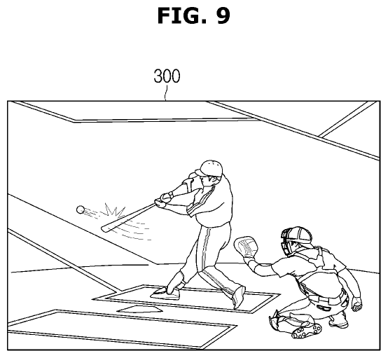

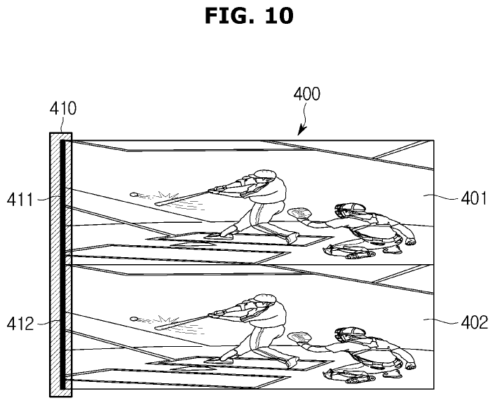

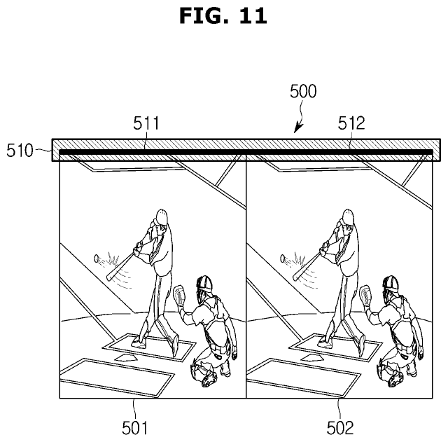

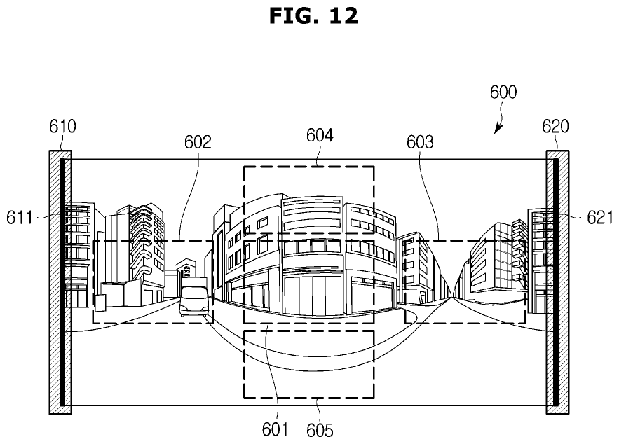

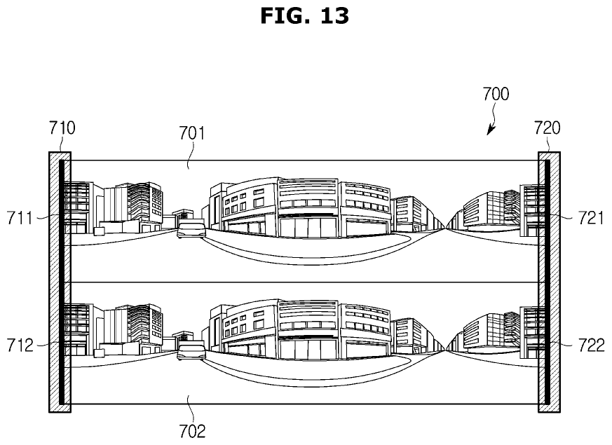

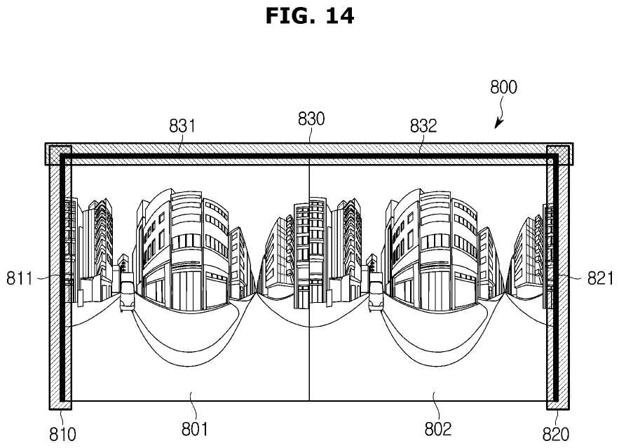

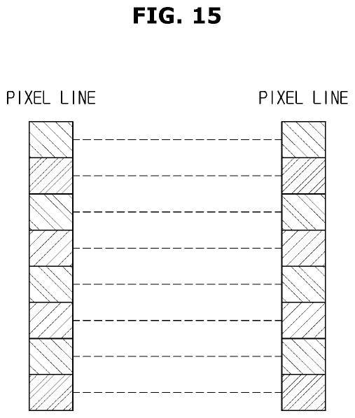

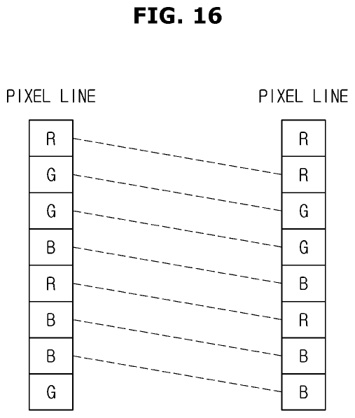

FIG. 8 is a view illustrating a configuration of a controller included in a wearable display apparatus according to an embodiment. FIG. 9 is a view illustrating an example of a plane image. FIG. 10 is a view illustrating an example of a top-and-bottom stereoscopic image. FIG. 11 is a view illustrating an example of a side-by-side stereoscopic image. FIG. 12 is a view illustrating an example of a 360-degree VR image. FIG. 13 is a view illustrating an example of a 360-degree top-and-bottom stereoscopic image. FIG. 14 is a view illustrating an example of a 360-degree side-by-side stereoscopic image. FIGS. 15 and 16 are views illustrating an example of determining whether a pixel line is matched by a wearable display apparatus according to an embodiment.

Referring to FIGS. 8 to 16, the controller 140 may include an analog front end (AFE) 210, an image decoder 220 and a stereoscopic image renderer 230.

The analog front end 210 may convert analog video signals (modulated image data) output from the content receiver 120 into digital codes (image data). The content receiver 120 may receive an analog type image signal (image data), and the controller 140 may process digital type image data (image signal). Accordingly, the analog front end 210 of the controller 140 may convert the analog type image signal into the digital type image data.

The image decoder 220 may decode the compressed/encoded image data, and restore the image frame from the compressed/encoded video data. For example, the image decoder 220 may decode the compressed/encoded image data using the image compression standard such as H.264/MPEG-4 AVC or H.265/HEVC.

The stereoscopic image renderer 230 may render the stereoscopic image from the decoded image frame. Particularly, the stereoscopic image renderer 230 may process the image frame including the left-eye image and the right-eye image so that the user can feel the three-dimensional effect according to a stereoscopic image display method of the wearable display apparatus 100.

For example, the wearable display apparatus 100 may display the stereoscopic image of both eyes as illustrated in FIG. 3. In this case, the stereoscopic image renderer 230 may separate the stereoscopic image into the left-eye image and the right-eye image to render the stereoscopic image, and may arrange the left-eye image and the right-eye image side by side.

The wearable display apparatus 100 may display a single stereoscopic image as illustrated in FIG. 5. In this case, the stereoscopic image renderer 230 may cut the left-eye image and the right-eye image into a plurality of strip-shaped left-eye image pieces and a plurality of strip-shaped right-eye image pieces, and may generate the stereoscopic image by alternately arranging the plurality of left-eye image pieces and the plurality of right-eye image pieces.

At this time, the image frame of the stereoscopic image decoded by the image decoder 220 may have various formats, and the stereoscopic image renderer 230 may render the stereoscopic image from the image frame in different ways according to the format of the image frame.

For example, the image frame may be a plane image 300. The plane image 300 may be displayed on a two-dimensional plane, as illustrated in FIG. 9, and may not include information about a depth of the image.

The image frame may be a top-and-bottom stereoscopic image 400. The top-and-bottom stereoscopic image 400 may be divided into an upper region 401 and a lower region 402 as illustrated in FIG. 10, and the left-eye images and the right-eye images may be located in the upper region 401 and the lower region 402. For example, the left-eye image may be located in the upper region 401 and the right-eye image may be located in the lower region 402. However, the present disclosure is not limited thereto, and the right-eye image may be located in the upper region 401 and the left-eye image may be located in the lower region 402.

The image frame may be a side-by-side stereoscopic image 500. The side-by-side stereoscopic image 500 may be divided into a left region 501 and a right region 502 as illustrated in FIG. 11, and the left-eye images and the right-eye images may be located in the left region 501 and the right region 502. For example, the left-eye image may be located in the left region 501 and the right-eye image may be located in the right region 502. However, the present disclosure is not limited thereto, and the right-eye image may be located in the left region 501 and the left-eye image may be located in the right region 502.

The image frame may be a 360-degree VR image 600. The 360-degree VR image 600 may be an image in which an around view is implemented on the two-dimensional plane as illustrated in FIG. 12. The 360-degree VR image 600 may include information about a gaze direction of the user U. The controller 140 of the wearable display apparatus 100 may determine the gaze direction of the user U based on the output of the posture detector 130, and may output some images of the 360-degree VR image 600 to the display 150 according to the gaze direction of the user U. As a result, the wearable display apparatus 100 may display another image on the screen 102 according to the gaze direction of the user U.

The image frame may be a 360-degree top-and-bottom stereoscopic image 700. The 360-degree top-and-bottom stereoscopic image 700 may be divided into an upper region 701 and a lower region 702 as illustrated in FIGS. 13, and 360-degree left-eye images and 360-degree right-eye images may be located in the upper region 701 and the lower region 702.

The image frame may be a 360-degree side-by-side stereoscopic image 800. The 360-degree side-by-side stereoscopic image 800 may be divided into a left region 801 and a right region 802, as illustrated in FIG. 14, and the 360-degree left-eye images and the 360-degree right-eye images may be located in the left region 801 and the right region 802.

As such, the image data of various formats may be received through the content receiver 120. The stereoscopic image renderer 230 of the controller 140 may determine the format of the image data and render the stereoscopic image according to the determined format.

The stereoscopic image renderer 230 may determine the format of the image data based on image characteristics of various formats.

When the image frame is the plane image 300, the stereoscopic image renderer 230 may not render the plane image 300 as the stereoscopic image, but may output the plane image 300 to the display 150 as it is. As a result, the wearable display apparatus 100 may display the entire plane image 300 through the display 150 as it is.

When the image frame is the top-and-bottom stereoscopic image 400, the stereoscopic image renderer 230 may separate the top-and-bottom stereoscopic image 400 into the image of the upper region 401 and the image of the lower region 402. In addition, the stereoscopic image renderer 230 may control the display 150 so that the image of the upper region 401 is displayed on the left-eye screen 102L (or the right screen), and may control the display 150 so that the image of the lower region 402 is displayed on the right-eye screen 102R (or the left screen).

In addition, when the image frame is the top-and-bottom stereoscopic image 400, the stereoscopic image renderer 230 may cut the image of the upper region 401 into a plurality of top image pieces, and may cut the image of the lower region 402 into a plurality of bottom image pieces. In addition, the stereoscopic image renderer 230 may generate the stereoscopic image by alternately arranging the plurality of top image pieces and the plurality of bottom image pieces.

The stereoscopic image renderer 230 may analyze the image frame to determine whether the image frame is the top-and-bottom stereoscopic image 400.

As illustrated in FIG. 10, the top-and-bottom stereoscopic image 400 may include the left-eye image disposed in the upper region 401 and the right-eye image disposed in the lower region 402. The left-eye image and right-eye image may be the same or similar.

As described above, the left-eye image and the right-eye image may be images captured by the same object at different positions (the position of the left eye and the position of the right eye), respectively. In other words, the left-eye image and the right-eye image may be as different as a person's parallax. Therefore, the left-eye image and the right-eye image may be the same or similar to each other.

The stereoscopic image renderer 230 may determine whether the image frame is the top-and-bottom stereoscopic image 400 based on the identity or similarity between the image disposed in the upper region 401 and the image disposed in the lower region 402.

The stereoscopic image renderer 230 may extract a pixel line of a side edge portion 410 from the image. In FIG. 10, the stereoscopic image renderer 230 may extract the pixel line of the left side edge portion 410, but is not limited thereto, and the stereoscopic image renderer 230 may extract the pixel line of the right side edge portion 410. Thereafter, the stereoscopic image renderer 230 may be divided into an upper pixel line 411 and a lower pixel line 412 based on a center of the extracted pixel line.

The stereoscopic image renderer 230 may determine whether the upper pixel line 411 and the lower pixel line 412 match to determine whether the image frame is the top-and-bottom stereoscopic image 400. Here, the “matching” may include similarity as well as identity. In other words, the “matching” of the upper pixel line 411 and the lower pixel line 412 may include not only that the upper pixel line 411 and the lower pixel line 412 are the same, but also that the difference between the upper pixel line 411 and the lower pixel line 412 is within an error range.

As illustrated in FIG. 15, the stereoscopic image renderer 230 may compare luminance values of pixels included in the upper pixel line 411 and luminance values of pixels included in the lower pixel line 412 to determine whether the upper pixel line 411 and the lower pixel line 412 match.

The stereoscopic image renderer 230 may sequentially compare the luminance values of pixels included in the upper pixel line 411 and the luminance values of pixels included in the lower pixel line 412. The luminance value of a first pixel of the upper pixel line 411 and the luminance value of a first pixel of the lower pixel line 412 may be compared, the luminance value of a second pixel of the upper pixel line 411 and the luminance value of a second pixel of the lower pixel line 412 may be compared, and the luminance value of a third pixel of the upper pixel line 411 and the luminance value of a third pixel of the lower pixel line 412 may be compared. In this way, the luminance value of a last pixel of the upper pixel line 411 may be compared with the luminance value of a last pixel of the lower pixel line 412.

When the luminance values of the pixels included in the upper pixel line 411 and the luminance values of the pixels included in the lower pixel line 412 match each other, the stereoscopic image renderer 230 may determine that the image frame is the top-and-bottom stereoscopic image 400. In addition, when the luminance values of the pixels included in the upper pixel line 411 and the luminance values of the pixels included in the lower pixel line 412 do not match each other, the stereoscopic image renderer 230 may determine that the image frame is not the top-and-bottom stereoscopic image 400.

The stereoscopic image renderer 230 may compare a luminance arrangement of pixels included in the upper pixel line 411 and a luminance arrangement of pixels included in the lower pixel line 412 to determine whether the upper pixel line 411 and the lower pixel line 412 match.

Even if the luminance values of the pixels included in the upper pixel line 411 and the luminance values of the pixels included in the lower pixel line 412 do not match each order, when the luminance arrangement of the pixels included in the upper pixel line 411 matches the luminance arrangement of the pixels included in the lower pixel line 412, the stereoscopic image renderer 230 may determine that the upper pixel line 411 and the lower pixel line 412 match. For example, the stereoscopic image renderer 230 may calculate a cross correlation coefficient between the luminance arrangement of the upper pixel line 411 and the luminance arrangement of the lower pixel line 412, and may determine whether the upper pixel line 411 and the lower pixel line 412 match based on the cross correlation coefficient.

As illustrated in FIG. 16, the stereoscopic image renderer 230 may compare colors of the pixels included in the upper pixel line 411 and colors of pixels included in the lower pixel line 412 to determine whether the upper pixel line 411 and the lower pixel line 412 match. Color data may include an R value representing red, a G value representing green, and a B value representing blue.

The stereoscopic image renderer 230 may sequentially compare the R value/G value/B value of the pixels included in the upper pixel line 411 and the R value/G value/B value of the pixels included in the lower pixel line 412. The R value/G value/B value of the first pixel of the upper pixel line 411 may be compared with the R value/G value/B value of the first pixel of the lower pixel line 412, the luminance of the second pixel of the upper pixel line 411 may be compared with the R value/G value/B value of the second pixel of the lower pixel line 412, and the luminance of the third pixel of the upper pixel line 411 may be compared with the R value/G value/B value of the third pixel of the lower pixel line 412. In this way, the R value/G value/B value of the last pixel of the upper pixel line 411 may be compared with the R value/G value/B value of the last pixel of the lower pixel line 412.

When the R value/G value/B value of the pixels included in the upper pixel line 411 and the R value/G value/B value of the pixels included in the lower pixel line 412 match each other, the stereoscopic image renderer 230 may determine that the image frame is the top-and-bottom stereoscopic image 400. In addition, when the R value/G value/B value of the pixels included in the upper pixel line 411 and the R value/G value/B value of the pixels included in the lower pixel line 412 do not match each other, the stereoscopic image renderer may determine that the image frame is not the top-and-bottom stereoscopic image 400.

In order to determine whether the upper pixel line 411 and the lower pixel line 412 match, the stereoscopic image renderer 230 may compare the color arrangement of pixels included in the upper pixel line 411 and the color arrangement of pixels included in the lower pixel line 412.

Even if the R value/G value/B value of the pixels included in the upper pixel line 411 and the R value/G value/B value of the pixels included in the lower pixel line 412 do not match each order, when the R value/G value/B value arrangement of pixels included in the upper pixel line 411 matches the R value/G value/B value arrangement of pixels included in the lower pixel line 412, the stereoscopic image renderer 230 may determine that the upper pixel line 411 and the lower pixel line 412 match.

When the upper pixel line 411 and the lower pixel line 412 match, the stereoscopic image renderer 230 may determine that the image frame is the top-and-bottom stereoscopic image 400.

When the image frame is the side-by-side stereoscopic image 500, the stereoscopic image renderer 230 may separate the side-by-side stereoscopic image 500 into the image of the left region 501 and the image of the right region 502. The stereoscopic image renderer 230 may control the display 150 so that the image of the left region 501 is displayed on the left-eye screen 102L (or the right screen), and may control the display 150 so that the image of the right region 502 is displayed on the right-eye screen 102R (or the left screen).

In addition, when the image frame is the side-by-side stereoscopic image 500, the stereoscopic image renderer 230 may cut the image of the left region 501 into a plurality of left image pieces, and may cut the image of the right region 502 into a plurality of right image pieces. In addition, the stereoscopic image renderer 230 may generate the stereoscopic image by alternately arranging the plurality of left image pieces and the plurality of right image pieces.

The stereoscopic image renderer 230 may analyze the image frame to determine whether the image frame is the side-by-side stereoscopic image 500.

As illustrated in FIG. 11, the side-by-side stereoscopic image 500 may include the left-eye image disposed in the left region 501 and the right-eye image disposed in the right region 502. The left-eye image and right-eye image may be the same or similar.

The stereoscopic image renderer 230 may determine whether the image frame is the side-by-side stereoscopic image 500 based on the identity or similarity between the image disposed in the left region 501 and the image disposed in the right region 502.

The stereoscopic image renderer 230 may extract pixel lines of an upper (or lower) edge portion 510 from the image frame. In FIG. 11, the stereoscopic image renderer 230 may extract the pixel line of the upper edge portion 510, but is not limited thereto, and the stereoscopic image renderer 230 may extract the pixel line of the lower edge portion. Thereafter, the stereoscopic image renderer 230 may be separated into a left pixel line 511 and a right pixel line 512 based on the center of the extracted pixel line.

The stereoscopic image renderer 230 may determine whether the left pixel line 511 and the right pixel line 512 match to determine whether the image frame is the side-by-side stereoscopic image 500. A method of determining whether the left pixel line 511 and the right pixel line 512 match may be the same as a method of determining whether the upper pixel line 411 and the lower pixel line 412 described above match.

When the left pixel line 511 and the right pixel line 512 match, the stereoscopic image renderer 230 may determine that the image frame is the side-by-side stereoscopic image 500.

When the image frame is the 360-degree VR image 600, the stereoscopic image renderer 230 may output some images of the 360-degree VR image 600 to the display 150 according to the gaze direction of the user U.

The controller 140 may determine the gaze direction of the user U based on the output of the posture detector 130.

The controller 140 may be set in a reference direction based on the output of the posture detector 130 when the 360-degree VR image 600 is first played, and the stereoscopic image renderer 230 may output the image of a front region 601 of the 360-degree VR image 600 to the display 150. When the rotation to the left is detected by the posture detector 130, the controller 140 may determine that the gaze direction of the user U is rotated to the left, and the stereoscopic image renderer 230 may output the image of a left region 602 of the 360-degree VR image 600 to the display 150. When the rotation to the right is detected by the posture detector 130, the controller 140 may determine that the gaze direction of the user U is rotated to the right, and the stereoscopic image renderer 230 may output the image of a right region 603 of the 360-degree VR image 600 to the display 150. In this way, when the rotation to the upper side is detected by the posture detector 130, the stereoscopic image renderer 230 may output the image of an upper region 604 of the 360-degree VR image 600 to the display 150. When the rotation to the lower side is detected by the posture detector 130, the stereoscopic image renderer 230 may output the image of a lower region 605 of the 360-degree VR image 600 to the display 150.

The stereoscopic image renderer 230 may analyze the image frame to determine whether the image frame is the 360-degree VR image 600.

The 360-degree VR image 600 represents the image of a surrounding 360-degree region, and thus may be continuous throughout the image. In other words, a left edge portion 610 of the 360-degree VR image 600 may be continuous with a right edge portion 620. Accordingly, the left edge portion 610 and the right edge portion 620 of the 360-degree VR image 600 may be the same or similar.

The stereoscopic image renderer 230 may determine whether the image frame is the 360-degree VR image 600 based on the identity or similarity between the left edge portion 610 and the right edge portion 620 of the image frame.

The stereoscopic image renderer 230 may extract a left edge pixel line 611 of the left edge portion 610 and a right edge pixel line 621 of the right edge portion 620 from the image frame.

The stereoscopic image renderer 230 may determine whether the left edge pixel line 611 and the right edge pixel line 621 match to determine whether the image frame is the 360-degree VR image 600. The method of determining whether the left edge pixel line 611 and the right edge pixel line 621 match is the same as the method of determining whether the upper pixel line 411 and the lower pixel line 412 described above match.

When the left edge pixel line 611 and the right edge pixel line 612 match, the stereoscopic image renderer 230 may determine the image frame as the 360-degree VR image 600.

When the image frame is the 360-degree top-and-bottom stereoscopic image 700, the stereoscopic image renderer 230 may separate the 360-degree top-and-bottom stereoscopic image 700 into the image of the upper region 701 and the image of the lower region 702. The stereoscopic image renderer 230 may control the display 150 so that the image of the upper region 701 is displayed on the left-eye screen 102L (or the right screen), and may control the display 150 so that the image of the lower region 702 is displayed on the right-eye screen 102R (or the left screen).

In addition, when the image frame is the 360-degree top-and-bottom stereoscopic image 700, the stereoscopic image renderer 230 may cut the image of the upper region 701 into the plurality of top image pieces, and may cut the image of the lower region 702 into the plurality of bottom image pieces. In addition, the stereoscopic image renderer 230 may generate the stereoscopic image by alternately arranging the plurality of top image pieces and the plurality of bottom image pieces.

Thereafter, the stereoscopic image renderer 230 may output some of the images in the stereoscopic image to the display 150 according to the gaze direction of the user U. This may be the same as the stereoscopic image renderer 230 outputting some of the images in the 360-degree VR image 600 to the display 150 according to the gaze direction of the user U.

The stereoscopic image renderer 230 may analyze the image frame to determine whether the image frame is the 360-degree top-and-bottom stereoscopic image 700.

As illustrated in FIG. 13, the 360-degree top-and-bottom stereoscopic image 700 may include the left-eye image disposed in the upper region 701 and the right-eye image disposed in the lower region 702. The left edge portion 710 of the 360-degree top-and-bottom stereoscopic image 700 may be continuous with the right edge portion 720.

The stereoscopic image renderer 230 may determine the identity or similarity between the image disposed in the upper region 701 and the image disposed in the lower region 702, and may determine the continuity between the left edge portion 710 and the right edge portion 720 of the image frame.

When the continuity between the left edge portion 710 and the right edge portion 720 of the image frame is determined, the stereoscopic image renderer 230 may determine the image as the 360-degree VR image. When the image is determined to be the 360-degree VR image, the stereoscopic image renderer 230 may determine whether the image is the 360-degree top-and-bottom stereoscopic image 700 in the following manner.

In order to determine the identity or similarity between the image disposed in the upper region 701 and the image disposed in the lower region 702, the stereoscopic image renderer 230 may extract the pixel lines of the side edge portions 710 and 720 from the image frame. For example, the stereoscopic image renderer 230 may extract the pixel lines from the left edge portion 710 of the image frame. Thereafter, the stereoscopic image renderer 230 may be divided into an upper pixel line 711 and a lower pixel line 712 based on the center of the extracted pixel line.

The stereoscopic image renderer 230 may determine whether the upper pixel line 711 and the lower pixel line 712 match. The method of determining whether the upper pixel line 711 and the lower pixel line 712 match may be the same as the method of determining whether the upper pixel line 711 and the lower pixel line 712 described above match.

In order to determine the continuity between the left edge portion 710 and the right edge portion 720 of the image frame, the stereoscopic image renderer 230 may extract the left edge pixel lines 711 and 712 of the left edge portion 710 and right edge pixel lines 721 and 722 of the right edge portion 720 from the image frame.

The stereoscopic image renderer 230 may determine whether the left edge pixel lines 711 and 712 and the right edge pixel lines 721 and 722 match. The method of determining whether the left edge pixel lines 711 and 712 and the right edge pixel lines 721 and 722 match may be the same as the method of determining whether the upper pixel line 411 and the lower pixel line 412 described above match.

When the upper pixel line 711 and the lower pixel line 712 are matched and the left edge pixel lines 711 and 712 and the right edge pixel lines 721 and 722 are matched, the stereoscopic image renderer 230 may determine the image frame as the 360-degree top-and-bottom stereoscopic image 700.

When the image frame is the 360-degree side-by-side stereoscopic image 800, the stereoscopic image renderer 230 may separate the 360-degree side-by-side stereoscopic image 500 into the image of the left region 801 and the image of the right region 802. The stereoscopic image renderer 230 may control the display 150 so that the image of the left region 801 is displayed on the left-eye screen 102L (or the right screen), and may control the display 150 so that the image of the right region 802 is displayed on the right-eye screen 102R (or the left screen).

In addition, when the image frame is the 360-degree side-by-side stereoscopic image 800, the stereoscopic image renderer 230 may cut the image of the left region 801 into the plurality of left image pieces, and may cut the image of the right region 802 into the plurality of right image pieces. In addition, the stereoscopic image renderer 230 may generate the stereoscopic image by alternately arranging the plurality of left image pieces and the plurality of right image pieces.

Thereafter, the stereoscopic image renderer 230 may output some of the images in the stereoscopic image to the display 150 according to the gaze direction of the user U. This may be the same as the stereoscopic image renderer 230 outputting some of the images in the 360-degree VR image 600 to the display 150 according to the gaze direction of the user U.

The stereoscopic image renderer 230 may analyze the image frame to determine whether the image frame is the 360-degree side-by-side stereoscopic image 800.

As illustrated in FIG. 14, the 360-degree side-by-side stereoscopic image 800 may include the left-eye image disposed in the left region 801 and the right-eye image disposed in the right region 802. A left edge portion 810 of the 360-degree side-by-side stereoscopic image 800 may be continuous with a right edge portion 820.

The stereoscopic image renderer 230 may determine the identity or similarity between the image disposed in the left region 801 and the image disposed in the right region 802, and may determine the continuity between the left edge portion 810 and the right edge portion 820 of the image frame.

When the continuity between the left edge portion 810 and the right edge portion 820 of the image frame is determined, the stereoscopic image renderer 230 may determine the image as the 360-degree VR image. When the image is determined to be the 360-degree VR image, the stereoscopic image renderer 230 may determine whether the image is the 360-degree side-by-side stereoscopic image 800 in the following manner.

In order to determine the identity or similarity between the image disposed in the left region 801 and the image disposed in the right region 802, the stereoscopic image renderer 230 may extract the pixel lines of the left edge portion 810 and the right edge portion 820 from the image frame. For example, the stereoscopic image renderer 230 may extract the pixel lines from an upper edge portion 830 of the image frame. Thereafter, the stereoscopic image renderer 230 may be divided into a left pixel line 831 and a right pixel line 832 based on the center of the extracted pixel line.

The stereoscopic image renderer 230 may determine whether the left pixel line 831 and the right pixel line 832 match. The method of determining whether the left pixel line 831 and the right pixel line 832 match may be the same as the method of determining whether the upper pixel line 411 and the lower pixel line 412 described above match.

In order to determine the continuity between the left edge portion 810 and the right edge portion 820 of the image frame, the stereoscopic image renderer 230 may extract the left edge pixel line 811 of the left edge portion 810 and the right edge pixel line 821 of the right edge portion 820 from the image frame.

The stereoscopic image renderer 230 may determine whether the left edge pixel line 811 and the right edge pixel line 821 match. The method of determining whether the left edge pixel line 811 and the right edge pixel line 821 match may be the same as the method of determining whether the upper pixel line 411 and the lower pixel line 412 described above match.

When the left pixel line 831 and the right pixel line 832 are matched and the left edge pixel line 811 and the right edge pixel line 812 are matched, the stereoscopic image renderer 230 may determine the image frame as the 360-degree side-by-side stereoscopic image 800.

As described above, the wearable display apparatus 100 may receive the image frames of various formats from the content source 10. The wearable display apparatus 100 may automatically determine the format of the image frame based on the edge portion of the image frame. In addition, the wearable display apparatus 100 may render the stereoscopic image in a mutual manner according to the format of the image frame.

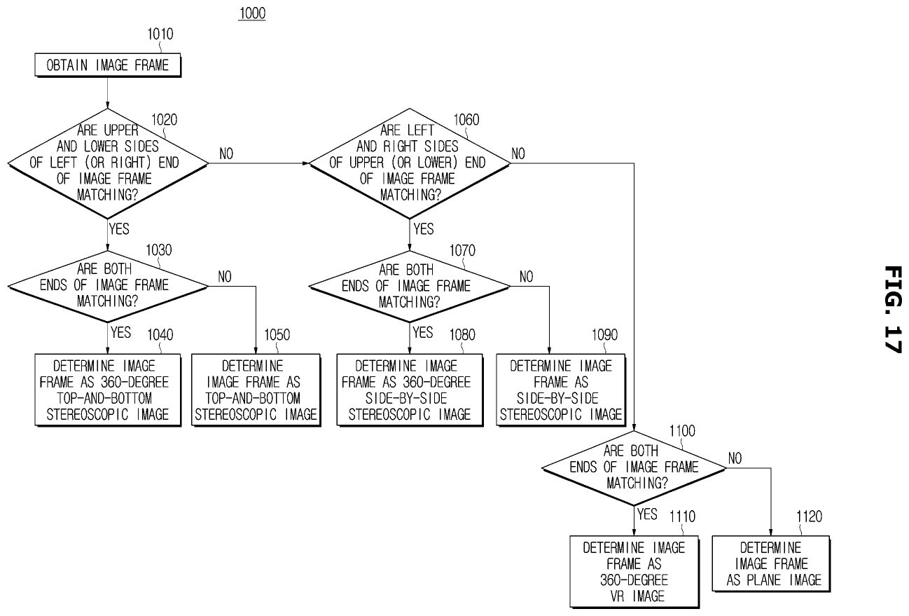

FIG. 17 is a view illustrating a method of determining a format of an image frame by a wearable display apparatus according to an embodiment.

Referring to FIG. 17, a method 1000 of determining the format of the image frame by the wearable display apparatus 100 is described.

The wearable display apparatus 100 may obtain the image frame (1010).

The content receiver 120 of the wearable display apparatus 100 may receive the image data from the content source 10 and output the image data to the controller 140.

The controller 140 may receive the image data from the content receiver 120 and decode the image data to restore the image frame.

The wearable display apparatus 100 may determine whether the upper pixel line and the lower pixel line of the left (or right) edge portion of the image frame match (1020).

The controller 140 may extract the pixel line of the left edge portion of the image frame. Also, the controller 140 may be divided into the upper pixel line and the lower pixel line based on the center of the pixel line.

The controller 140 may determine whether the upper pixel line and the lower pixel line match. For example, the controller 140 may compare the luminance values of the pixels in the upper pixel line with the luminance values of the pixels in the lower pixel line, compare the luminance arrangement of the pixels in the upper pixel line and the luminance arrangement of the pixels in the lower pixel line, compare the color (R value/G value/B value) of the pixels in the upper pixel line and the color (R value/G value/B value) of the pixels in the lower pixel line, or compare the color (R value/G value/B value) arrangement of the pixels in the upper pixel line and the color (R value/G value/B value) arrangement of the pixels in the lower pixel line.

When the upper pixel line and the lower pixel line match (YES in 1020), the wearable display apparatus 100 may determine whether the left edge pixel line and the right edge pixel line of the image frame match (1030).

The controller 140 may extract the pixel lines of the left edge portion and the pixel lines of the right edge portion of the image frame.

The controller 140 may determine whether the left edge pixel line and the right edge pixel line match. The method of determining whether the left edge pixel line and the right edge pixel line match may be the same as the method of determining whether the upper pixel line and the lower pixel line described in operation 1020 match.

When the left edge pixel line and the right edge pixel line match (YES in 1030), the wearable display apparatus 100 may determine the image frame as the 360-degree top-and-bottom stereoscopic image (1040).

Since the upper pixel line and the lower pixel line of the left (or right) edge portion of the image frame are matched and the left edge pixel line and the right edge pixel line of the image frame are matched, the controller 140 may determine the image frame as the 360-degree top-and-bottom stereoscopic image.

The controller 140 may separate the 360-degree top-and-bottom stereoscopic image into the upper region and the lower region, and may control the display 150 to display the image of the upper region on the left-eye screen 102L and the image of the lower region on the right-eye screen 102R.

The controller 140 may cut the image of the upper region into the plurality of top image pieces and cut the image of the lower region into the plurality of bottom image pieces. The controller 140 may alternately arrange the plurality of top image pieces and the plurality of bottom image pieces to generate the stereoscopic image.

In addition, the controller 140 may output some of the stereoscopic images to the display 150 according to the gaze direction of the user U.

When the left edge pixel line and the right edge pixel line do not match (NO in 1030), the wearable display apparatus 100 may determine the image frame as the top-and-bottom stereoscopic image (1050).

Since the upper pixel line and the lower pixel line of the left (or right) edge portion of the image frame match, the controller 140 may determine the image frame as the top-and-bottom stereoscopic image.

The controller 140 may separate the top-and-bottom stereoscopic image into the upper region and the lower region, display the image of the upper region on the left-eye screen 102L, and control the display 150 to display the image of the lower region on the right-eye screen 102R.

The controller 140 may cut the image of the upper region into the plurality of top image pieces and cut the image of the lower region into the plurality of bottom image pieces. The controller 140 may alternately arrange the plurality of top image pieces and the plurality of bottom image pieces to generate the stereoscopic image. In addition, the controller 140 may output the entire stereoscopic image to the display 150.

When the upper pixel line and the lower pixel line do not match (YES in 1020), the wearable display apparatus 100 may determine whether the left pixel line and the right pixel line of the upper (or lower) edge portion of the image frame match (1060).

The controller 140 may extract the pixel line of the upper edge portion of the image frame. Also, the controller 140 may be divided into the left pixel line and the right pixel line based on the center of the pixel line.

The controller 140 may determine whether the left pixel line and the right pixel line match. The method of determining whether the left pixel line and the right pixel line match may be the same as the method of determining whether the upper pixel line and the lower pixel line described in operation 1020 match.

When the left pixel line and the right pixel line match (YES in 1060), the wearable display apparatus 100 may determine whether the left edge pixel line and the right edge pixel line of the image frame match (1070).

Operation 1070 may be the same as operation 1030.

When the left edge pixel line and the right edge pixel line match

(YES in 1070), the wearable display apparatus 100 may determine the image frame as the 360-degree side-by-side stereoscopic image (1080).

Since the left pixel line and the right pixel line of the upper (or lower) edge portion of the image frame match and the left edge pixel line and the right edge pixel line of the image frame match, the controller 140 may determine the image frame as the 360-degree side-by-side stereoscopic image.

The controller 140 may separate the 360-degree side-by-side stereoscopic image into the left region and the right region, and control the display 150 to display the image of the left region on the left-eye screen 102L and the image of the right region on the right-eye screen 102R.

The controller 140 may cut the image of the left region into the plurality of left image pieces and cut the image of the right image into the plurality of right image pieces. The controller 140 may alternately arrange the plurality of left image pieces and the plurality of right image pieces to generate the stereoscopic image.

In addition, the controller 140 may output some of the stereoscopic images to the display 150 according to the gaze direction of the user U.

When the left edge pixel line and the right edge pixel line do not match (NO in 1070), the wearable display apparatus 100 may determine the image frame as the side-by-side stereoscopic image (1090).

Since the left pixel line and the right pixel line of the upper (or lower) edge portion of the image frame match, the controller 140 may determine the image frame as the side-by-side stereoscopic image.

The controller 140 may separate the 360-degree side-by-side stereoscopic image into the left region and the right region, and control the display 150 to display the image of the left region on the left-eye screen 102L and the image of the right region on the right-eye screen 102R.

The controller 140 may cut the image of the left region into the plurality of left image pieces and cut the image of the right image into the plurality of right image pieces. The controller 140 may alternately arrange the plurality of left image pieces and the plurality of right image pieces to generate the stereoscopic image. In addition, the controller 140 may output the entire stereoscopic image to the display 150.

When the left pixel line and the right pixel line do not match (NO in 1060), the wearable display apparatus 100 may determine whether the left edge pixel line and the right edge pixel line of the image frame match (1100).

Operation 1100 may be the same as operation 1030.

When the left edge pixel line and the right edge pixel line match (YES in 1100), the wearable display apparatus 100 may determine the image frame as the 360-degree VR image (1110).

Because the left edge pixel line and the right edge pixel line of the image frame match, the controller 140 may determine the image frame as the 360-degree VR image. The controller 140 may output the portion of the 360-degree VR image to the display 150 according to the gaze direction of the user U.

When the left edge pixel line and the right edge pixel line do not match (NO in 1100), the wearable display apparatus 100 may determine the image frame as the plane image (1120).

Since there is no matching part among the edges of the image frame, the controller 140 may determine the image frame as the plane image. The controller 140 may output all of the plain images to the display 150.

As described above, the wearable display apparatus 100 may automatically determine the format of the image frame, and may render the stereoscopic image in the mutual manner according to the format of the image frame.

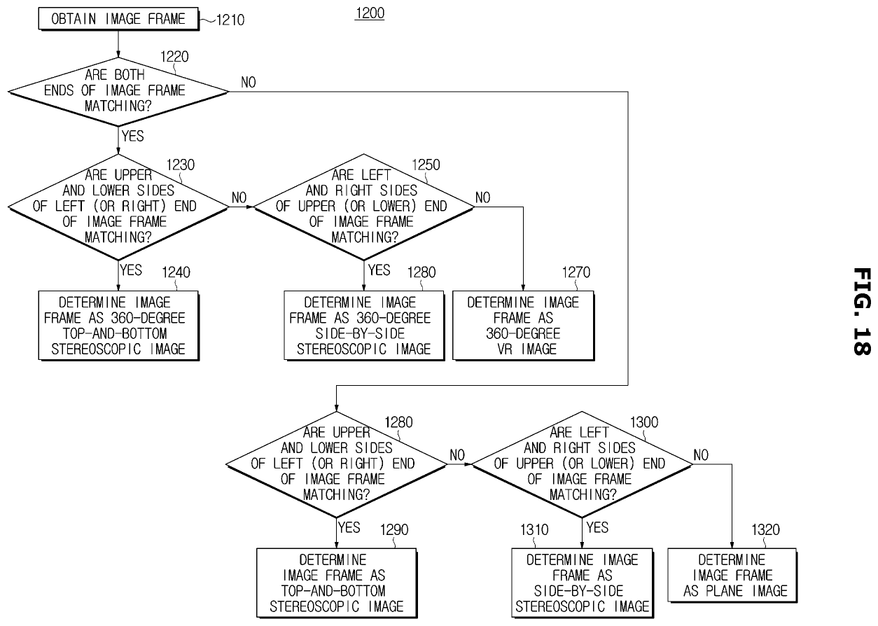

FIG. 18 is a view illustrating another example of a method of determining a format of an image frame by a wearable display apparatus according to an embodiment.

Referring to FIG. 18, a method 1200 of determining the format of the image frame by the wearable display apparatus 100 is described.

The wearable display apparatus 100 may obtain the image frame (1210).

Operation 1210 may be the same as operation 1010 illustrated in FIG. 17.

The wearable display apparatus 100 may determine whether the left edge pixel line and the right edge pixel line of the image frame match (1220).

The controller 140 may extract the pixel line of the left edge portion and the pixel line of the right edge portion of the image frame.

The controller 140 may determine whether the left edge pixel line and the right edge pixel line match. The method of determining whether the left edge pixel line and the right edge pixel line match may be the same as the method described in operation 1020 of FIG. 17.

When the left edge pixel line and the right edge pixel line match (YES in 1220), the wearable display apparatus 100 may determine whether the upper pixel line and the lower pixel line of the left (or right) edge portion of the image frame match (1230).

The controller 140 may extract the pixel line of the left edge portion of the image frame. Also, the controller 140 may be divided into the upper pixel line and the lower pixel line based on the center of the pixel line.

The controller 140 may determine whether the upper pixel line and the lower pixel line match. The method of determining whether the upper pixel line and the lower pixel line match may be the same as the method described in operation 1020 of FIG. 17.

When the upper pixel line and the lower pixel line match (YES in 1230), the wearable display apparatus 100 may determine the image frame as the 360-degree top-and-bottom stereoscopic image (1240).

The controller 140 may implement the 360-degree top-and-bottom stereoscopic image as the 360-degree stereoscopic image on the display 150. A method of implementing the 360-degree top-and-bottom stereoscopic image as the 360-degree stereoscopic image may be the same as operation 1040 illustrated in FIG. 17.

When the upper pixel line and the lower pixel line do not match (YES in 1230), the wearable display apparatus 100 may determine whether the left pixel line and the right pixel line of the upper (or lower) edge portion of the image frame match (1250).

The controller 140 may extract the pixel line of the upper edge portion of the image frame. Also, the controller 140 may be divided into the left pixel line and the right pixel line based on the center of the pixel line.

The controller 140 may determine whether the left pixel line and the right pixel line match. The method of determining whether the left pixel line and the right pixel line match may be the same as the method described in operation 1020 of FIG. 17.

When the left pixel line and the right pixel line match (YES in 1250), the wearable display apparatus 100 may determine the image frame as the 360-degree side-by-side stereoscopic image (1260).

The controller 140 may implement the 360-degree side-by-side stereoscopic image as the 360-degree stereoscopic image on the display 150. A method of implementing the 360-degree side-by-side stereoscopic image as the 360-degree stereoscopic image may be the same as operation 1080 illustrated in FIG. 17.

When the left pixel line and the right pixel line do not match (NO in 1250), the wearable display apparatus 100 may determine the image frame as the 360-degree VR image (1270).

The controller 140 may display the 360-degree VR image on the display 150. A method of displaying the 360-degree VR image may be the same as operation 1110 illustrated in FIG. 17.

When the left edge pixel line and the right edge pixel line do not match (NO in 1220), the wearable display apparatus 100 may determine whether the upper pixel line and the lower pixel line of the left (or right) edge portion of the image frame match (1280).

The controller 140 may extract the pixel line of the left edge portion of the image frame. Also, the controller 140 may be divided into the upper pixel line and the lower pixel line based on the center of the pixel line.

The controller 140 may determine whether the upper pixel line and the lower pixel line match. A method of determining whether the upper pixel line and the lower pixel line match may be the same as the method described in operation 1020 of FIG. 17.

When the upper pixel line and the lower pixel line match (YES in 1230), the wearable display apparatus 100 may determine the image frame as the top-and-bottom stereoscopic image (1290).

The controller 140 may implement the top-and-bottom stereoscopic image as the stereoscopic image on the display 150. A method of implementing the top-and-bottom stereoscopic image as the stereoscopic image may be the same as operation 1050 illustrated in FIG. 17.

When the upper pixel line and the lower pixel line do not match (YES in 1280), the wearable display apparatus 100 may determine whether the left pixel line and the right pixel line of the upper (or lower) edge portion of the image frame match (1300).

The controller 140 may extract the pixel line of the upper edge portion of the image frame. Also, the controller 140 may be divided into the left pixel line and the right pixel line based on the center of the pixel line.

The controller 140 may determine whether the left pixel line and the right pixel line match. A method of determining whether the left pixel line and the right pixel line match may be the same as the method described in operation 1020 of FIG. 17.

When the left pixel line and the right pixel line match (YES in 1300), the wearable display apparatus 100 may determine the image frame as the side-by-side stereoscopic image (1310).

The controller 140 may implement the side-by-side stereoscopic image as the stereoscopic image on the display 150. A method of implementing the side-by-side stereoscopic image as the stereoscopic image may be the same as operation 1090 illustrated in FIG. 17.

When the left pixel line and the right pixel line do not match (NO in 1300), the wearable display apparatus 100 may determine the image frame as a general plane image (1320).

The controller 140 may display the plane image on the display 150. A method of displaying the plane image may be the same as operation 1120 illustrated in FIG. 17.

Meanwhile, the disclosed embodiments may be implemented in the form of a recording medium storing instructions that are executable by a computer. The instructions may be stored in the form of a program code, and when executed by a processor, the instructions may generate a program module to perform operations of the disclosed embodiments. The recording medium may be implemented as a computer-readable recording medium.

The computer-readable recording medium may include all kinds of recording media storing commands that can be interpreted by a computer. For example, the computer-readable recording medium may be ROM, RAM, a magnetic tape, a magnetic disc, flash memory, an optical data storage device, etc.

Embodiments and examples of the disclosure have thus far been described with reference to the accompanying drawings. It will be obvious to those of ordinary skill in the art that the disclosure may be practiced in other forms than the embodiments as described above without changing the technical idea or essential features of the disclosure. The above embodiments are only by way of example, and should not be interpreted in a limited sense.

1. A wearable display apparatus comprising:
an image display;
a content receiver; and
a processor configured to process image data received through the content receiver to generate an image frame, and control the image display to display the image frame,
wherein the processor is configured to
compare a vertical pixel line of a left edge portion of the image frame with a vertical pixel line of a right edge portion of the image frame, and
when it is determined that the image frame is a 360-degree Virtual Reality (VR) image, process the 360-degree VR image.

2. The wearable display apparatus according to claim 1, wherein the processor is configured to
compare a left half and a right half of a horizontal pixel line of an upper or lower edge portion of the image frame, and
when it is determined that the image frame is a 360-degree top-and-bottom stereoscopic image, process the 360-degree top-and-bottom stereoscopic image.

3. The wearable display apparatus according to claim 2, wherein the processor is configured to
generate the 360-degree top-and-bottom stereoscopic image from the image frame, and
control the image display to display a part of the 360-degree top-and-bottom stereoscopic image.

4. The wearable display apparatus according to claim 1, wherein the processor is configured to
compare an upper half and a lower half of the vertical pixel line of the left or right edge portion of the image frame, and
when it is determined that the image frame is a 360-degree side-by-side stereoscopic image, process the 360-degree side-by-side stereoscopic image.

5. The wearable display apparatus according to claim 4, wherein the processor is configured to
generate the 360-degree side-by-side stereoscopic image from the image frame, and
control the image display to display a part of the 360-degree side-by-side stereoscopic image.

6. The wearable display apparatus according to claim 1, wherein the processor is configured to
compare the vertical pixel line of the left edge portion of the image frame and the vertical pixel line of the right edge portion of the image frame,
compare a left half and a right half of a horizontal pixel line of an upper or lower edge portion of the image frame,
when it is determined that the image frame is a top-and-bottom stereoscopic image, process the top-and-bottom stereoscopic image, and
control the image display to display the top-and-bottom stereoscopic image.

7. The wearable display apparatus according to claim 1, wherein the processor is configured to
compare the vertical pixel line of the left edge portion of the image frame and the vertical pixel line of the right edge portion of the image frame,
compare an upper half and a lower half of the vertical pixel line of the left or right edge portion of the image frame,
when it is determined that the image frame is a side-by-side stereoscopic image, process the side-by-side stereoscopic image, and
control the image display to display the side-by-side stereoscopic image.

8. The wearable display apparatus according to claim 1, wherein the processor is configured to compare the vertical pixel line of the left edge portion of the image frame and the vertical pixel line of the right edge portion of the image frame by comparing a luminance of the vertical pixel line of the left edge portion of the image frame and a luminance of the vertical pixel line of the right edge portion of the image frame.

9. The wearable display apparatus according to claim 1, wherein the processor is configured to compare the vertical pixel line of the left edge portion of the image frame and the vertical pixel line of the right edge portion of the image frame by comparing a color of the vertical pixel line of the left edge portion of the image frame and a color of the vertical pixel line of the right edge portion of the image frame.

10. A method of controlling a wearable display apparatus comprising:
receiving, by a content receiver, image data;
generating, by a processor, an image frame by processing the image data;
determining, by the processor, the image frame as a 360-degree Virtual Reality (VR) image, by comparing a vertical pixel line of a left edge portion of the image frame and a vertical pixel line of a right edge portion of the image frame; and
processing, by the processor, the 360-degree VR image.

11. The method according to claim 10, further comprising:
comparing, by the processor, a left half and a right half of a horizontal pixel line of an upper or lower edge portion of the image frame; and
when it is determined that the image frame is a 360-degree top-and-bottom stereoscopic image, processing, by the processor, the 360-degree top-and-bottom stereoscopic image.

12. The method according to claim 11, further comprising:
generating, by the processor, the 360-degree top-and-bottom stereoscopic image from the image frame; and
displaying, by an image display, a part of the 360-degree top-and-bottom stereoscopic image.

13. The method according to claim 10, further comprising:
comparing, by the processor, an upper half and a lower half of the vertical pixel line of the left or right edge portion of the image frame; and
when it is determined that the image frame is a 360-degree side-by-side stereoscopic image, processing, by the processor, the 360-degree side-by-side stereoscopic image.

14. The method according to claim 13, further comprising:
generating, by the processor, the 360-degree side-by-side stereoscopic image from the image frame; and
displaying, by an image display, a part of the 360-degree side-by-side stereoscopic image.

15. The method according to claim 10, wherein the comparing of the vertical pixel line of the left edge portion of the image frame and the vertical pixel line of the right edge portion of the image frame comprises:
comparing a luminance of the vertical pixel line of the left edge portion of the image frame and a luminance of the vertical pixel line of the right edge portion of the image frame; and
comparing a color of the vertical pixel line of the left edge portion of the image frame and a color of the vertical pixel line of the right edge portion of the image frame.
